(19) United States
(12) Patent Application Publication
(10) Pub. No.: US 2011/0205226 A1
(43) Pub. Date: Aug. 25, 2011

(54) GENERATION OF OCCLUSION DATA FOR IMAGE PROPERTIES

(75) Inventors: Felix Gremse, Eindhoven (BE); Vasanth Philomin, Eindhoven (DE); Fang Liu, Eindhoven (DE)

(73) Assignee: KONINKLIJKE PHILIPS ELECTRONICS N.V., EINDHOVEN (NL)

(21) Appl. No.: 13/125,857

(22) PCT Filed: Oct. 21, 2009
(86) PCT No.: PCT/IB2009/054638

§ 371 Date: Apr. 25, 2011

(30) Foreign Application Priority Data
Oct. 28, 2008 (EP) 08167688.4

(51) Int. Cl. G06T 15/00

(52) U.S. Cl. 345/419

(57) ABSTRACT

A method of generating an occlusion image property map for an occlusion viewing position for a three dimensional scene is provided. The occlusion image property map comprises at least some image property values that are occluded from the occlusion viewing position. The method utilises an algorithm which can generate an image property map for an image representing the scene as a function of a viewing position. The method generates (701, 703) image property map for different viewing positions by performing the algorithm for these positions. The occlusion image property map is generated (705) from the image property maps of different viewing positions. Specifically, the image property maps may in some examples be shifted to the occlusion viewing position and data of the occlusion image property map is then selected as a pixel from the shifted image property maps which does not correspond to the most forward pixel (unless all pixels have equal depth).

### FIELD OF THE INVENTION

The invention relates to generation of occlusion data for image properties and in particular, but not exclusively, to generation of an occlusion image for a layered representation of three dimensional image data.

### BACKGROUND OF THE INVENTION

Three dimensional displays are receiving increasing interest and significant research in how to provide three dimensional perception to a viewer is undertaken. Three dimensional (3D) displays add a third dimension to the viewing experience by providing a viewer's two eyes with different views of the scene being watched. This can be achieved by having the user wear glasses to separate two views that are displayed. However, as this may be considered inconvenient to the user, it is in many scenarios preferred to use autostereoscopic displays that use means at the display (such as lenticular lenses, or barriers) to separate views, and to send them in different directions where they individually may reach the user's eyes. For stereo displays, two views are required whereas autostereoscopic displays typically require more views (such as e.g. nine views).

In order to effectively support 3D presentation it is important that a suitable data representation of the generated 3D content is used. For example, for different stereo displays the two views are not necessarily the same and an optimal viewing experience typically requires an adaptation of the content data for the particular combination of screen size and viewer distance. The same considerations tend to apply to autostereoscopic displays.

A popular approach for representing three dimensional images is to use one or more layered two dimensional images plus depth representation. For example, a foreground and background image, each image with associated depth information, may be used to represent a three dimensional scene.

Such an approach provides a number of advantages including allowing three dimensional views to be generated with relatively low complexity and providing an efficient data representation thereby reducing e.g. storage and communication resource requirements for three dimensional image (and video) signals. The approach also allows two dimensional images to be generated with different viewpoints and viewing angles than the two dimensional images that are included in the three dimensional representation. Furthermore, the representation may easily be adapted to and support different display configurations e.g. with different numbers of views such as 5, 9 or 15.

When rendering a view from a different viewing angle than that represented by the layered images, foreground pixels are shifted depending on their depth. This leads to regions becoming visible that are occluded for the original viewing angle (i.e. with the camera/viewing position being translated/shifted to the side). These regions are then filled out using the background layer, or if suitable background layer data is not available by repeating pixels of the foreground image. However, such pixel replication may result in visible artefacts. The background information is typically only required around edges of foreground image objects and is accordingly highly compressible for most content.

In order to achieve high quality 3D perception, the generation of the 3D image content is critical. Various methods for creating 3D content is known including for example, computer generated content tools that may generate images based on data describing a three dimensional scene. For example, computer generated foreground and background images for e.g. a computer game may be generated based on data characterising the environment including foreground image objects etc. For example, several programs for generating 3D models are known and many of these programs may be enhanced by a software plug-in that can generate 3D image representations in the form of one or more layered images with associated depth maps (as well as possibly transparency maps). Thus, following the design of a 3D model in a 3D modelling program, an algorithm may based on this 3D model generate a background and one or more foreground layers that represent the view from a defined viewing angle. Furthermore, one or more depth maps and transparency maps may be generated for this view. The image layers and depth and transparency maps may then provide a 3D representation that is suitable for use by e.g. stereo or autostereoscopic displays.

However, although such approaches may be useful in many embodiments, they tend to have some associated disadvantages. For example, the generation of multiple layers tend to be very complex and require significant manual intervention. E.g. in order to generate the background layer, it must be specified which image objects or areas should be considered foreground and thus removed when generating the background image. However, in order to provide an accurate 3D representation and high quality background, this must typically be done manually by an operator resulting in a very complex and time consuming generation of 3D image data. Thus, in current approaches, the background layer is typically created by manually removing some foreground objects and rendering the content again. However, this not only requires a lot of effort but also leads to problems when e.g. an object occludes itself or casts shadows on the background.

Another technique is to specify a cutting plane that removes all image areas and objects that are closer than a given threshold. However, such an approach tends to result in a non optimal background layer because the optimal background layer requires different cutting thresholds in different regions (i.e. the appropriate depth level suitable for removing foreground image objects depends on the specific 3D model and is not constant over the image). Indeed, a single cutting plane is rarely optimal and choosing multiple cutting planes tends to complicate the process even further.

Thus, the generation of information that provides occlusion data information for a foreground tends to be suboptimal and in particular tends to be complex, resource demanding and/or result in suboptimal quality. Indeed, the described problems are not limited to generation of occlusion image data but also relates to generation of data which represents other image properties, such as transparency or depth information.

Hence, an improved approach for generating occlusion data would be advantageous and in particular an approach allowing increased flexibility, reduced complexity, simplified operation, reduced resource requirement, improved quality and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a method of generating an occlusion image property map for an occlusion viewing position for a three dimensional scene, the occlusion image property map comprising at least some image property values occluded from the occlusion viewing position; the method comprising: providing an algorithm arranged to generate an image property map for an image representing the three dimensional scene as a function of a viewing position; generating a first image property map by performing the algorithm for a first viewing position; determining a second image property map by performing the algorithm for a second viewing position, the second viewing position having a first offset relative to the first viewing position; and generating the occlusion image property map in response to the first image property map and the second image property map.

The invention may in many embodiments provide improved and/or simplified generation of an occlusion image property map. The occlusion image property map may specifically comprise image property data for image areas that are occluded by a (more) foreground image property map layer generated for the occlusion viewing position. For example, the occlusion image property map may be a background (or middle ground) image layer providing image data occluded by a foreground (or further forward middle ground) image layer.

The invention may in particular allow occlusion information to be generated without requiring manual intervention and/or without defining any cutting planes for the information. Rather, a simple repeated execution of the algorithm may be used to provide an occlusion image property map. The invention may in particular allow a layered 3D image property representation of a scene to be generated from different image property maps that are generated based on the same 3D model but at different viewing positions. Thus, a single rendering algorithm based on a 3D model may be used repeatedly to generate a plurality of ( ) image property maps that are then post-processed to generate a layered 3D representation. The invention may reduce resource usage and/or complexity. In particular, the post processing of the (non-layered, varying viewing angle) image property maps may typically be implemented with low complexity and/or low resource usage.

The different viewing positions may specifically correspond to viewing positions that are shifted in a plane which is perpendicular to the viewing direction for the first viewing position—and specifically shifted sideways in this plane. The viewing angle/direction for each viewing position may be substantially the same, i.e. the viewing direction for the first and second viewing position (and thus the first and second image property map) may be substantially the same.

The approach may allow improved backwards compatibility with many existing algorithms. For example, the first algorithm may be an existing 3D modelling application which is further enhanced by a software tool/plug in that generates the layered 3D image property map representation. Thus, the post-processing may e.g. be provided as a plugin for content creation tools.

The occlusion image property map may represent the same viewing angle as an image property map for which the occlusion data is provided. Specifically, the occlusion image property map may be a layered image property map with another image property map representing the occlusion viewing position. The occlusion image property map may specifically be an occlusion image property map for the first image property map and may represent the first viewing position. Specifically, the occlusion viewing position may be substantially the same as the first viewing position.

The first algorithm may specifically be (based on) a 3D model algorithm. The first and second image property map may thus be generated using the same 3D model for the scene. The viewing position(s) may specifically be a viewing angle. In some embodiments and for some considerations a distance is not considered. The term viewing position may in many scenarios be considered equivalent to the term viewing angle. The first and second viewing positions correspond to different viewing angles. The image property maps may specifically comprise an image property value for each pixel of the first image.

The occlusion image property map may further be generated in response to other (types of) image property maps. For example, the first and second image property maps may be supplemented by image property maps that have e.g. been generated by manually removing foreground objects before rendering of an image property map corresponding to the occlusion viewing position.

In accordance with an optional feature of the invention, determining the occlusion image property map comprises: generating a modified set of image property maps corresponding to the occlusion viewing position by shifting at least the first image property map and the second image property map to the occlusion viewing position; and determining the occlusion image property map by selecting image properties for pixels of the occlusion image property map from corresponding pixels of the modified set of image property maps.

This may provide improved and/or simplified generation of an occlusion image property map in many embodiments. The set of image property maps may comprise a plurality of modified image property maps obtained by shifting/translation of image property maps for different viewing positions to the occlusion viewing position. The shifting/translation may specifically be to the same viewing angle. For image property maps generated by the algorithm for substantially the occlusion viewing position, the modified image property map may be the same as the generated image property map. Specifically, the shifting/translation to the occlusion viewing position may be a null operation for image property maps that are already representing the occlusion viewing position.

In some embodiments, selecting image properties for pixels of the occlusion image property map may comprise selecting image properties for a first corresponding pixel in preference to a second corresponding pixel if the second corresponding pixel is a de-occluded pixel and the first pixel is not a de-occluded pixel. For example, when generating a modified image property map, values that are occluded in the original image but not from the occlusion viewing position are de-occluded. Thus, in the modified image property maps some pixel values are typically de-occluded pixels (e.g. generated by pixel repetition) whereas other pixels are not de-occluded. Specifically, a non-repeated pixel may be selected in preference to a repeated pixel.

In accordance with an optional feature of the invention, the selection between corresponding pixels of the modified set of image property maps is in response to depth values for the corresponding pixels.

This may provide improved and/or simplified generation of an occlusion image property map in many embodiments.

In accordance with an optional feature of the invention, the selection between corresponding pixels comprises selecting an image property for a first pixel of the occlusion image property map as an image property for a corresponding pixel not having a depth value corresponding to a most forward depth for the corresponding pixels for the first pixel.

This may provide improved and/or simplified generation of an occlusion image property map in many embodiments. In particular, selecting the image property for the second depth value (from the front) for each pixel tends to provide occlusion data for the first objects behind foreground images. These will typically be the most appropriate to render at different viewing angles and accordingly tend to provide the most useful occlusion information.

In accordance with an optional feature of the invention, the selection between corresponding pixels comprises selecting an image property for a first pixel of the occlusion image property map as an image property for a corresponding pixel having a depth value corresponding to a second most forward depth for the corresponding pixels for the first pixel.

This may provide improved and/or simplified generation of an occlusion image property map in many embodiments. In particular, selecting the image property for the second depth value (from the front) for each pixel tends to provide occlusion data for the first objects behind foreground images. These will typically be the most appropriate to render at different viewing angles and accordingly tend to provide the most useful occlusion information.

It will be appreciated that alternatively the selection between corresponding pixels comprises selecting an image property for a first pixel of the occlusion image property map as an image property for a corresponding pixel having a depth value corresponding to a third, fourth, fifth etc most forward depth for the corresponding pixels for the first pixel. This may for example allow an efficient generation of multiple layers of image property maps.

In accordance with an optional feature of the invention, generating at least one of the modified set of image property maps comprises generating a plurality of image property values for pixels corresponding to overlapping image areas following the shifting.

This may provide improved and/or simplified generation of an occlusion image property map in many embodiments. In particular, it may allow all the information provided by the image property maps of different viewing positions to be considered when generating the occlusion image property map.

The plurality of pixels may specifically be pixels that are displaced to the same pixel position at the occlusion viewing position.

In accordance with an optional feature of the invention, the image property represented by the occlusion image property map, the first image property map and the second image property map comprises at least one image property selected from the group consisting of: image luminosity; image color; image object identification; transparency; and depth.

The invention may allow an improved and/or simplified generation of occlusion information for a number of different properties useful for a 3D image representation.

In accordance with an optional feature of the invention, the method further comprises determining a third image property map by performing the algorithm for a third viewing position, the third viewing position having a second offset relative to the first viewing position; and wherein determining the occlusion image property map is further in response to the third image.

This may allow an improved occlusion image property map to be generated in many embodiments. In particular, it may allow additional occlusion data to be determined and represented by the occlusion image property map. The second and third image property maps may e.g. allow occlusion information to be generated for shifts to both sides of a central view.

Determining the occlusion image property map may further comprise generating a modified third image property map by shifting/translating the third image property map from the third viewing position to the occlusion viewing position; and the modified third image property map may be included in the modified set of image property maps from which image properties for pixels of the occlusion image property map may be selected. The approach may also be extended to a fourth, fifth etc image property map generated from different viewing positions.

In accordance with an optional feature of the invention, the first offset is substantially opposite the second offset. Specifically, the viewing angle offset between the first viewing position and the third viewing position may be substantially the same as the viewing angle offset between the first viewing position and the second viewing position but in the opposite direction.

This may allow an improved occlusion image property map to be generated in many embodiments. In particular, occlusion data suitable for viewing angle changes in different direction may be generated.

The first offset and/or second offset may specifically be substantially in the horizontal plane.

In accordance with an optional feature of the invention, the method further comprises generating an image signal comprising the occlusion image property map and only including image property maps for the occlusion viewing position.

The invention may generate an efficient representation for a 3D image. A layered representation may be provided which includes a (further) foreground image property map (such as a foreground image) for a given viewing angle (corresponding to the occlusion viewing position), and the occlusion image property map representing the same viewing angle. However, no images or image property maps representing a different viewing angle may be included. Specifically, the image signal may comprise a number of channels (corresponding to different image properties such as image data, depth data and transparency data) at least one of which comprises a layered image property representation which includes an occlusion image property map generated by the method.

In accordance with an optional feature of the invention, the first offset corresponds to a viewing angle offset in the interval from 2° to 10° around an object at screen depth.

This may provide an occlusion image property map which is particularly suitable for rendering images for most stereo displays and/or autostereoscopic displays. In particular, it may provide an improved trade-off between the range of viewing angles that can be rendered using the generated occlusion image property map and the risk of gaps or holes in the data of the occlusion image property map.

In accordance with an optional feature of the invention, the first image property map, the second image property map and the occlusion image property map are images.

Thus, there may be provided a method of generating an occlusion image, the occlusion image comprising at least some image values for an occluded image object; the method comprising: providing a rendering algorithm arranged to generate an image representing a scene dependent on a viewing position; generating a first image by performing the algorithm for a first viewing position; determining a second image by performing the first algorithm for a second viewing position, the second viewing position having a first offset relative to the first viewing position; and generating the occlusion image in response to the first image and the second image.

The invention may in many embodiments provide improved and/or simplified generation of an occlusion image. The occlusion image may specifically comprise image data for image areas that are occluded by a (further) foreground image layer.

In accordance with another aspect of the invention, there is provided a computer program product for executing the method(s) described above.

In accordance with another aspect of the invention, there is provided a software tool for use with a three dimensional modelling computer program to generate an occlusion image property map for an occlusion viewing position for a three dimensional scene, the occlusion image property map comprising at least some image property values occluded from the occlusion viewing position and the three dimensional modelling computer program comprising an algorithm arranged to generate an image property map for an image representing the three dimensional scene as a function of a viewing position; the software tool being arranged to perform the steps of: generating a first image property map by performing the algorithm for a first viewing position; determining a second image property map by performing the algorithm for a second viewing position, the second viewing position having a first offset relative to the first viewing position; and generating the occlusion image property map in response to the first image property map and the second image property map.

In accordance with another aspect of the invention, there is provided an apparatus for generating an occlusion image property map for an occlusion viewing position for a three dimensional scene, the occlusion image property map comprising at least some image property values occluded from the occlusion viewing position; the apparatus comprising: means for providing an algorithm arranged to generate an image property map for an image representing the three dimensional scene as a function of a viewing position; means for generating a first image property map by performing the algorithm for a first viewing position; means for determining a second image property map by performing the algorithm for a second viewing position, the second viewing position having a first offset relative to the first viewing position; and means for generating the occlusion image property map in response to the first image property map and the second image property map.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a device for generating an occlusion image property map in accordance with some embodiments of the invention;

FIG. 2 illustrates an example of a rendering of an image based on a three dimensional model;

FIG. 3 illustrates an example of a rendering of an image based on a three dimensional model;

FIG. 4 illustrates an example of a method of generating an occlusion image property map from image property maps corresponding to different viewing positions in accordance with some embodiments of the invention;

FIG. 5 illustrates an example of a shifting/translation of an image property map from one viewing position to another;

FIG. 6 illustrates an example of a approach for generating an occlusion image property map from image property maps corresponding to different viewing positions in accordance with some embodiments of the invention; and

FIG. 7 illustrates an example of a method of generating an occlusion image property map in accordance with some embodiments of the invention.

### DETAILED DESCRIPTION OF SOME EMBODIMENTS OF THE INVENTION

The following description focuses on embodiments of the invention applicable to generation of an occlusion image for a foreground image. However, it will be appreciated that the invention is not limited to this application but may be applied to generation of other image property maps including for example image property maps reflecting image object identification, transparency; and depth properties.

For clarity and brevity, the following description will focus on the processing of a single image such as a still image. However, it will be appreciated that the described principles apply equally to e.g. animations and moving images. For example, the described processing may be applied individually to each image and depth map of a three dimensional video signal based on a layered depth model, so as to generate all views for each timestamp in a multi-view image sequence.

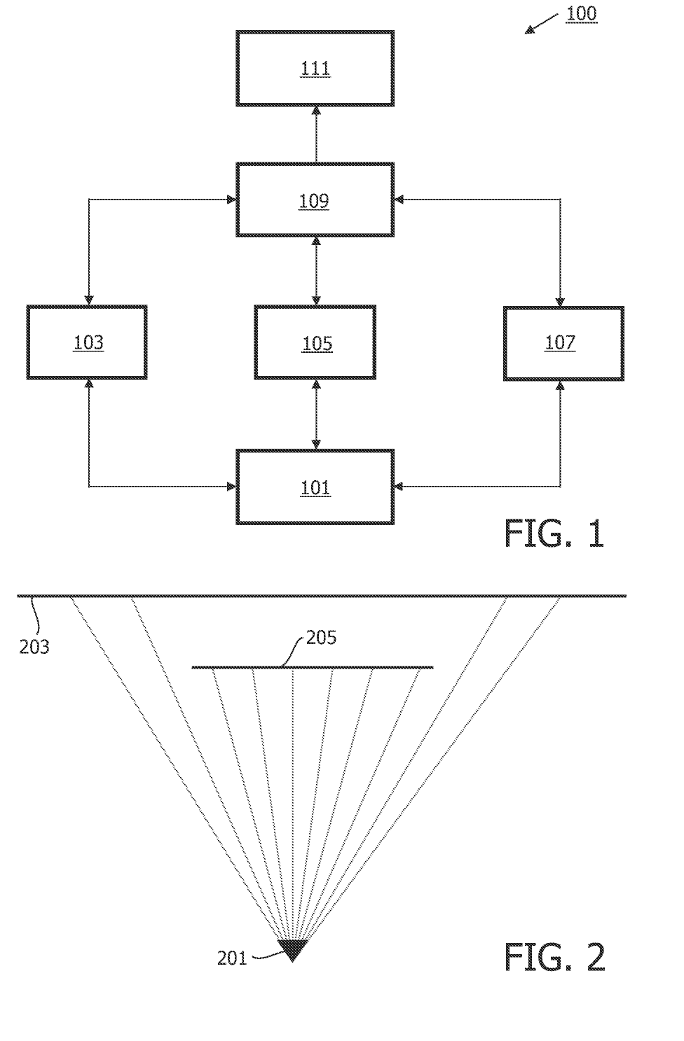

FIG. 1 illustrates an example of a device for generating an occlusion image property map.

The device comprises a map generator 101 which is arranged to generate an image property map for an image representing a scene. The image property map is generated as function of a viewing position and specifically as a function of a viewing angle. In particular, the map generator can generate an image map for a given specified viewing angle based on a 3D model. The 3D model may specifically define an artificial scene defined by a background image and a number of 3D objects in front of the background image.

In the example, the map generator 101 is arranged to generate an image that corresponds to the image which will be captured by a camera at the defined viewing position, and specifically the defined viewing angle. Thus, an image having a luminosity and/or colour value for each pixel reflecting the object of the 3D model which is visible from the specific viewing angle is generated. Thus, based on the defined artificial scene represented by the 3D model, the map generator 101 can generate an image based simply on a viewing angle input parameter.

It will be appreciated that many different algorithms and tools are known that may generate images and associated image property data for an artificial scene based on a 3D model and a definition of a viewing position. For example, offline computer 3D modelling tools are known and extensively used e.g. for computer aided design, games design, computer animations etc. Also, real time rendering of images for artificial 3D scenes is known e.g. from games or real time computer aided design applications. It will be appreciated that the map generator 101 may utilise any suitable method for generating image property maps.

It will also be appreciated that the map generator 101 may generate images or maps that correspond to other image properties. Thus, an image property may be any property that provides information of how an image can be rendered and may specifically be a 3D image property that provides information useful for generating images at different viewing angles.

For example, the map generator 101 may proceed to generate both an image for a given viewing angle as well as a depth map for the viewing angle. The depth map can specifically comprise a depth indication (such as a depth level or disparity value) for each pixel of the image where the depth indication reflects the depth in the image of the image object represented by the pixel.

Also, the map generator 101 may generate a transparency value for each pixel of the generated image. The transparency value may specifically represent a transparency of the image pixel.

As another example, the map generator 101 may generate an image object identification map which for each pixel of the generated image identifies the image object that corresponds to the pixel.

In the specific example, the map generator 101 generates a number of corresponding image property maps for the viewing angle. Each image property (type) may be referred to as a channel and in the specific example the map generator 101 generates an image channel comprising an image, a depth channel comprising a depth map for the generated image and in some scenarios a transparency map for the generated image and/or an image object identification map for the generated image.

In the example, each channel comprises only a single image property map and thus each image property is represented by a single non-layered image property map.

It will be appreciated that in other embodiments, the map generator 101 may only generate an image property map for a single channel, i.e. for a single image property. For example, a depth map may be generated without the image being generated.

The apparatus furthermore comprises a first image property map generator 103 which is coupled to the map generator 101. The first image property map generator 103 is arranged to generate a first image property map by executing the algorithm of the map generator 101 for a first viewing position. Specifically, the first image property map generator 103 may define a viewing angle or position for the scene and feed this to the map generator 101. In response, the map generator 101 proceeds to evaluate the 3D model to generate the image property maps that correspond to this viewing position.

In the specific example, the map generator 101 proceeds to generate a plurality of single layer channels with each channel corresponding to a different type of image property. Thus, the map generator 101 generates an image that represents a view of the scene/3D model from the specified viewing position/angle as well as a matching depth map and in some scenarios a matching transparency map and/or a matching object identification map. The channels comprising the different image property maps are then fed back to the first image property map generator 103.

FIG. 2 illustrates an example where a viewing position 201 is defined for a three dimensional scene/model that comprises a background object 203 and a foreground image object 205. The map generator 101 then proceeds to generate an image that reflects the specific image object that is seen in the different directions. In addition, a corresponding depth map is generated reflecting the depth of the image object visible in the image. The map generator 101 calculates a color value, a luminance value and a depth for each pixel. The color/luminance is determined by the closest object to the camera/viewing position along the ray of the pixel. Thus for pixels that correspond to the foreground image object 205, an image and depth value of the foreground object 205 is included and for pixels that correspond to the background object 203, an image and depth value of the background object 203 is included. Also, an object identification map may be generated which for each pixel indicates the image object (e.g. whether it is object 203 or 205) represented by the pixel. Similarly, a transparency map may be generated with a transparency indication for each pixel.

It will be appreciated that any suitable algorithm for generating an image property map (such as an image or a depth map) from a 3D scene or model may be used by the map generator 101.

The apparatus of FIG. 1 further comprises a second image property map generator 105 which is coupled to the map generator 101. The second image property map generator 105 is arranged to generate a second image property map by executing the algorithm of the map generator 101 for a second viewing position which is offset relative to the first viewing position. The second viewing position corresponds to a different viewing angle than the first viewing position. Thus, unless everything in the generated image property maps happen to be at the exact same depth level, the first and second image property maps may in some areas represent different image objects. Thus, the first and second image property map may comprise image property data for an image object area which is occluded by a (further forward) foreground image object in the other image property map.

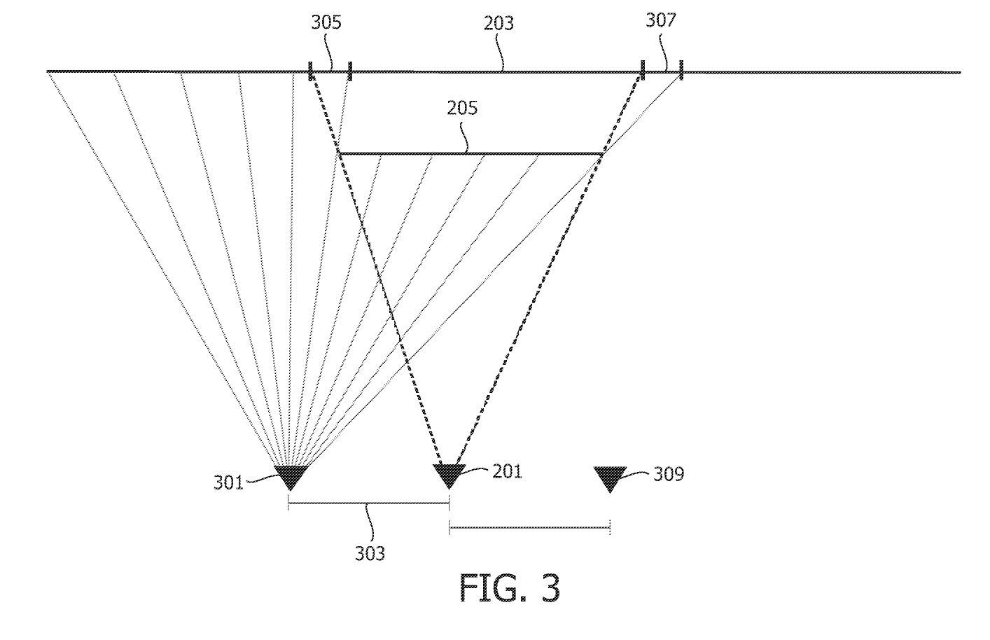

FIG. 3 illustrates the example of FIG. 2 with a second viewing position 301 having a relative offset 303 to the first viewing position. Due to the viewing angle offset, the image property map generated for the second viewing position 301 includes an area 305 of the background object 203 which is not included in the image property map for the first image viewing position 201 as it is occluded by the foreground object 205 for this viewing angle. Similarly, an area 307 of the background object 203 is only visible in the first image property map generated for the first viewing position.

Thus, the scene represented by the 3D model is rendered again from a shifted/translated/transferred viewing position. This second viewing position provides a ‘look around’ objects relative to the first viewing position. In the view from the second viewing position, objects appear shifted to the right with the shift being inversely proportional to the depth because of the perspective transformation.

In the specific example, the map generator 101 proceeds to generate a plurality of single layer channels for the second viewing position with each channel corresponding to a different type of image property. Specifically, the second image property map generator 105 receives an image, an associated depth map and possibly a transparency and image object identification map for the second viewing position.

The apparatus of FIG. 1 further comprises a third image property map generator 107 which is coupled to the map generator 101. The third image property map generator 107 is arranged to generate a third image property map by executing the algorithm of the map generator 101 for a third viewing position which is offset relative to the first viewing position and the second viewing position. The third viewing position corresponds to a different viewing angle than the first viewing position and the second viewing position.

The third viewing position may specifically be offset from the first viewing position in a substantially opposite direction of the second viewing position. Also, the offset may be symmetric around the first viewing position such that the viewing angle between the first and second viewing position is the same as the viewing angle between the first and third viewing position. For example, in FIG. 3, the second viewing position 301 is offset to the left of the first viewing position 201 and the third viewing position 309 may be offset by the same amount to the right of the first viewing position 201. The use of a third viewing position may allow the resulting occlusion data to be useful for de-occlusion of an image for viewing angle offsets in different directions. For example, if the image for the first viewing position is used as a foreground image, the occlusion data that can be generated from the second and third (left and right) viewing positions may allow the central image to be modified to reflect viewing angles to both the left and right of the central view.

The offset between the first and second viewing position (as well as the offset between the first and third viewing position) is in the specific example selected to correspond to a viewing angle offset belonging to the interval from 2° to 10° (both values included) around an object at screen depth. This may provide occlusion data which is particularly suitable for many practical 3D display applications as it provides occlusion data that is particularly suitable for typical viewing angle variations used in such applications. Furthermore, by restricting the viewing angle offsets, the risk of having gaps in the generated occlusion data (e.g. resulting from a small hole in a foreground object) may be reduced.

In the example of FIG. 3, image property maps are generated for three symmetric viewing positions. However, it will be appreciated that in other examples two, four or more viewing positions may be used and/or non-symmetric viewing positions may be employed.

The first image property map generator 103, the second image property map generator 105 and the third image property map generator 107 are coupled to an occlusion processor 109 which receives the image property maps from the first image property map generator 103, the second image property map generator 105 and the third image property map generator 107. The occlusion processor 109 then proceeds to generate an occlusion image property map from the three image property maps of respectively the first, second and third viewing position.

In the specific example, the occlusion processor 109 may for example receive an image and a depth map for each of the three viewing positions. It may then proceed to generate an occlusion image and depth map by selecting values from each of the three image and depth maps. The pixels for the occlusion image property map are selected to not represent the foreground image object if a corresponding value is available reflecting an image object which is not at the foreground. For example, in the example of FIG. 3 pixels may be selected from the image property map of the second viewing position for area 305 and from the image property map of the first viewing position for area 307.

Specifically, the occlusion processor 109 may be fed (or already be aware of) the offset of the side viewing positions and the field of view of the virtual cameras for the viewing positions. This may be used to transfer pixels from the side views to the central view. The process may be considered to correspond to unprojecting a pixel from the side view through the inverse projective transformation and then projecting it into the central view. These formulas collapse into a shift that is proportional to the parallax when parallel cameras are used.

Thus, an occlusion image property map may be generated which provides more information of non-foreground image properties than what is available for any single viewpoint. The occlusion data may in particular be generated to contain more data that reflects non-foreground image objects than is available from any single viewing position. The occlusion image property map is specifically generated to represent a view from a given viewing position or angle (referred to as the occlusion viewing position or angle) and containing at least some image property data which from this viewing position/angle is occluded by a (more) foreground image object. The occlusion image property map may be combined with another image property map representing the occlusion viewing position in order to provide a layered 3D representation of the image.

For example, the occlusion image and the first image (for the first, central viewing position) may be combined to provide a (mixed) foreground and background layer representation wherein the occlusion image for at least some pixels represent the image value for an image object that is not part of the foreground image object visible from the first viewing position. Thus, in this example the occlusion viewing position may be the same as the first viewing position.

The occlusion processor 109 is coupled to a signal generator 111 which generates an image signal comprising 3D information. Specifically, the signal generator 111 generates an image signal which comprises an image for the occlusion viewing position/angle, the occlusion image, a depth map for the image as well as optionally an occlusion depth map for the occlusion image property map. In some embodiments or scenarios a transparency map and occlusion transparency map and/or an object identification map and occlusion object identification map may additionally or alternatively be included.

It will also be appreciated that the image signal may comprise more than two layers for each image property channel. For example, a plurality of different level occlusion images may be generated and included in the image channel. However, although the occlusion image property map is generated from views of different viewing angles, the generated image signal may comprise image property maps only for the occlusion viewing angle.

The image signal is specifically generated such that at least one of the image property maps generated by the map generator 101 is included in the image signal whereas no other of the image property maps generated by the map generator are included in the image signal. Indeed, none or only one of the generated image property maps from the map generator may be included in the image signal in these examples. Specifically, the image of the image signal may correspond to the image generated for the first viewing position with the occlusion image providing additional occlusion data for this viewing position. Corresponding image property maps may be included for the other channels. Thus, the image signal may comprise image property maps for only one viewing angle, namely the occlusion viewing angle corresponding to the occlusion image property map. This viewing angle may specifically be the same as one of the viewing angles used to generate the image property maps by the map generator 101 but does not need to be so.

The approach may allow a low complexity, low resource usage and fully automatic generation of a layered image representation comprising occlusion data. Indeed, the approach needs no manual intervention or any definition of cutting planes etc. Thus, a low complexity and high quality generation of an efficient representation of 3D image data can be achieved. The approach furthermore allows existing 3D content creation tools to be used thereby providing improved backwards compatibility and flexibility.

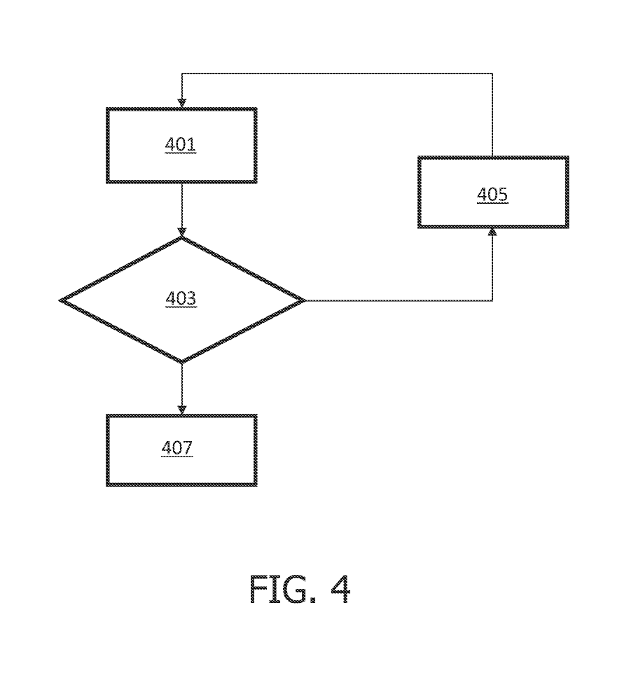

FIG. 4 illustrates the method which in the specific example is used by the occlusion processor 109. The method is based on shifting (or translating or transferring) all the generated image property maps (in the present case for the three different viewing positions) to the same viewing angle and then generating the occlusion image property map by selecting between the different image property maps for this viewing angle dependent on the depth levels.

The method of FIG. 4 initiates in step 401 wherein an image property map is shifted/transferred/translated to the viewing position for which the occlusion image property map is generated, i.e. to the occlusion viewing position/angle. In the specific example, the image signal is generated to comprise data corresponding to the first viewing position and thus the viewing position for the shifted image property maps is identical to the viewing position for the image property maps generated for the first viewing position. Specifically, each pixel from the side views may be shifted/transferred to the position in the central view where it would be seen if it was not occluded.

Step 401 is followed by step 403 wherein it is determined whether image property maps for all viewing positions have been shifted/transferred/translated to the common occlusion viewing position. If not, the method proceeds in step 405 wherein the next viewing position is selected. The method then returns to step 401 wherein the image property maps for this next viewing position are transferred to the occlusion viewing angle.

Thus, the occlusion processor 109 processes all viewing positions and for each viewing position, modified image property maps are generated that reflect the information contained in the image property map but which has been transferred or warped to correspond to the occlusion viewing position. Thus, in the example, the occlusion processor 109 determines three modified images, depth maps and optionally transparency and image object maps corresponding to the occlusion viewing angle from the images, depth maps and optionally transparency and image object maps generated for the first, second and third viewing positions/angles. It will be appreciated that in the specific example, the occlusion viewing position is equivalent to the central viewing position, i.e. to the first viewing position, and that accordingly the translation of the image property maps provided from the first image property map generator 103 may simply consist in retaining the image property maps without any processing or modification.

The translation of an image property map to the occlusion viewing angle may specifically be achieved by determining displacements for different pixels based on the depth of these pixels. This is then followed by a filing in any resulting de-occluded image areas. It will be appreciated that different algorithms for performing such viewing angle shifts will be known to the skilled person and that any suitable approach may be used.

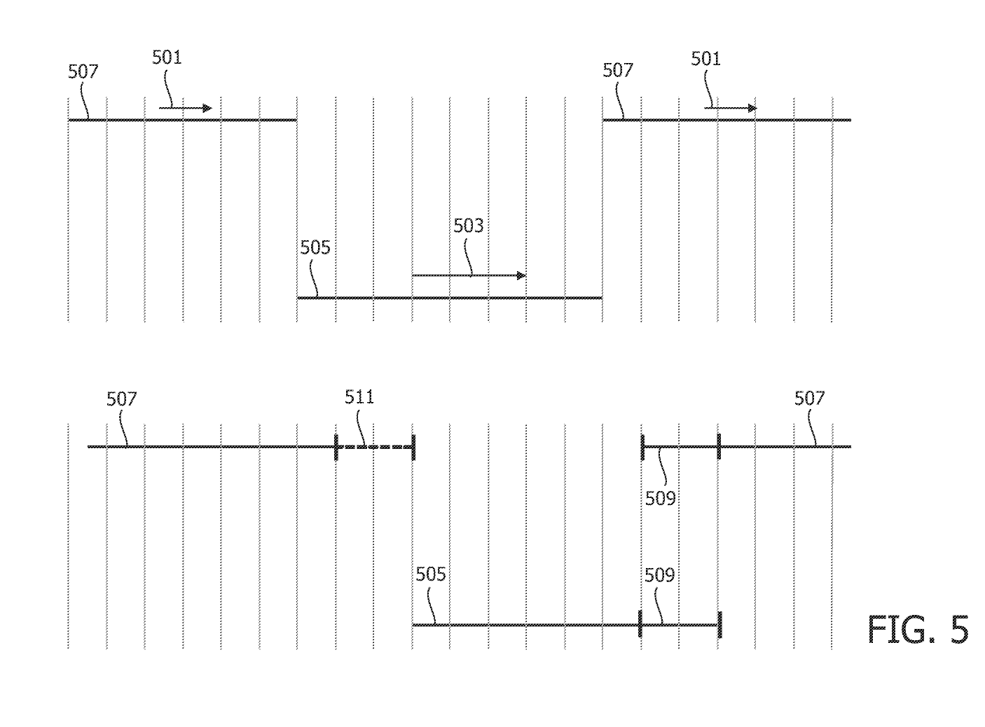

As a specific example, FIG. 5 illustrates an example of the generation of a modified second image from the image generated for the second viewing position.

The occlusion processor 109 first generates a displacement vector 501, 503 for each pixel or image area which is dependent on the depth of the pixel. Specifically, the pixels are shifted proportionally to their parallax (in practice the lines between adjacent pixels may be displaced and rasterized) and thus the shift is larger for closer (further foreground) image objects than for more distant (further background) image objects 507.

As a consequence, different pixels in different image regions (corresponding to image objects at different depths) will be shifted differently resulting in potential overlaps 509 of pixels as well as gaps 511 between pixels at the occlusion viewing angle. The gaps correspond to de-occluded image areas following the viewing angle modification and are filled in using a suitable single layer de-occlusion algorithm. Specifically, pixel replication where proximal pixels are copied to the de-occluded pixel areas may be used.

However, for the overlap areas 509, both pixel values are maintained as well as both depth levels. Thus, the generated modified image property map for the common viewing angle can contain a plurality of image property values for pixels that correspond to a plurality of pixels of the image property map being transferred. In particular, a plurality of image property values may be maintained for all pixels falling in an overlap area where separate image objects of the original image property map are displaced to the same pixels.

It will be appreciated that the described approach may be applied to any or all of the image property channels. In particular, an image, depth map, transparency map and/or image object map for the occlusion viewing angle may be generated using the described approach.

When the image property maps for all viewing angles have been transferred to the occlusion viewing angle, the method proceeds to step 407 wherein the occlusion map is generated for the occlusion viewing angle. At this stage, a set of (in this case) three image property maps is provided for each image property channel with all the image property maps reflecting the same viewing angle, namely the occlusion viewing angle. Accordingly, they may overlay each other directly resulting in a plurality of values to choose from for each pixel. The occlusion processor 109 then proceeds to select which value to use based on the associated depth values.

For example, an occlusion image is generated by for each pixel position selecting a pixel value from all the pixel values at that pixel position in the set of images generated in step 401. The pixel value that is selected depends on the depth value for the pixel position stored in the depth maps of the set of depth maps generated in step 401.

Specifically, for each pixel position, the occlusion processor 109 may proceed to select the image property value that corresponds to the second most forward depth value. Thus, for a pixel position wherein all depth values represent the same level, any pixel may be selected. This situation corresponds to a situation where all the original viewing positions provide the same information, e.g. where all viewing positions will have the same foreground or background object visible.

However, if different viewing angles have different viewing objects visible, this approach will result in the occlusion image property map taking the value of, not the most foreground image object, but rather the image object behind this. Thus, the occlusion image property map will include occlusion data that can be used to de-occlude the foreground image.

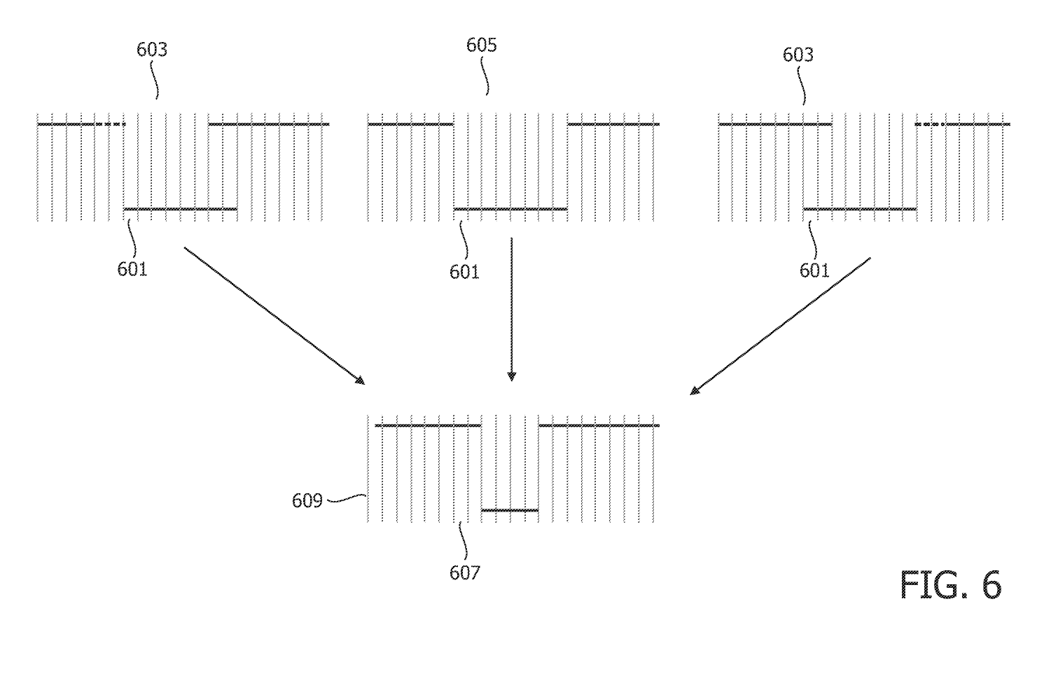

E.g. in the example where the occlusion viewing angle is identical to the central/first viewing angle, FIG. 6 illustrates how an image pixel 601 may be selected from the three shifted/transferred/translated images 603, 605 such that the corresponding image pixel 607 of the generated occlusion image 609 represents the background rather than the foreground which is visible from the first viewing position. Thus, the occlusion image 609 will be generated to contain additional background information and de-occlusion data for the first image 605. Furthermore, as the first image 605 and the occlusion image 609 correspond to the same viewing angle, they represent a layered 3D representation of the scene.

It will be appreciated that depth levels may be considered to be the same depth level for the purpose of selection if the difference between them is below a given value, or alternatively or additionally that the depth levels may use a relatively coarse quantisation for the selection step.

It will also be appreciated that in some embodiments or scenarios, the occlusion layer may be generated by selecting a second, third, forth etc most foreground depth level. Indeed, multiple occlusion layers may be generated by repeating the approach with a different level being selected in each iteration and by each occlusion layer.

It will be appreciated that in some examples, the depth level selection criterion may result in a plurality of suitable image property values being available from the set of transferred images. In this case, the selection may take into account other factors or parameters. For example, image property values present in the original image property maps prior to translation may be selected in preference to image property values that have been generated in the translation process. For example, an original image pixel value may be selected in preference to an image pixel value that has been generated by pixel replication.

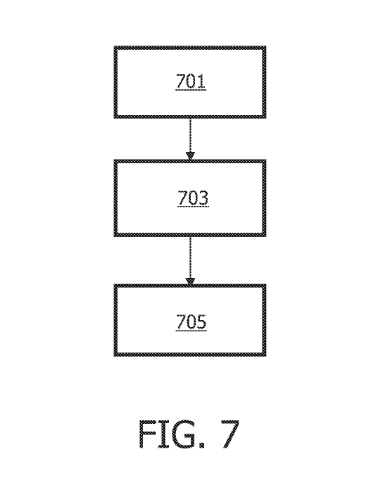

FIG. 7 illustrates an example of a method of generating an occlusion image property map for a first image where the occlusion image property map comprises at least some image property values occluded in the first image. The method uses a rendering algorithm which is capable of generating an image property map for an image representing a scene dependent on a viewing position.

The method initiates in step 701 wherein a first image property map is generated by performing the first algorithm for a first viewing position.

The method continues in step 703 wherein a second image property map is generated by performing the first algorithm for a second viewing position. It will be appreciated that steps 701 and/or 703 may be repeated for further image property maps corresponding to further viewing positions.

Step 703 is followed by step 705 wherein the occlusion image property map is generated in response to the first image and the second image. Step 705 may in particular execute the method of FIG. 4.

The occlusion image property map may then be combined with the first image or other image property maps to provide an efficient representation of 3D image data.

It will be appreciated that the method may specifically be executed on a processor or a computing platform, such as e.g. that described with reference to FIG. 1. Furthermore, it will be appreciated that the approach may allow a software tool to be used with a three dimensional modelling computer program to generate an occlusion image property map for an occlusion viewing position for a three dimensional scene. The occlusion image property map comprises at least some image property values that are occluded from the occlusion viewing position and the three dimensional modelling computer program comprises an algorithm arranged to generate an image property map for an image representing the three dimensional scene as a function of a viewing position. Specifically, the software tool may be a software plug-in for a 3D modelling software program or application and may specifically be arranged to implement the steps of: generating a first image property map by performing the algorithm for a first viewing position; determining a second image property map by performing the algorithm for a second viewing position, the second viewing position having a first offset relative to the first viewing position; and generating the occlusion image property map in response to the first image and the second image.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A method of generating an occlusion image property map for an occlusion viewing position for a three dimensional scene, the occlusion image property map comprising at least some image property values occluded from the occlusion viewing position; the method comprising:
providing an algorithm arranged to generate an image property map for an image representing the three dimensional scene as a function of a viewing position;
generating (701) a first image property map by performing the algorithm for a first viewing position;
determining (703) a second image property map by performing the algorithm for a second viewing position, the second viewing position having a first offset relative to the first viewing position; and
generating (705) the occlusion image property map in response to the first image property map and the second image property map.

2. The method of claim 1 wherein determining the occlusion image property map comprises:
generating (401, 403, 405) a modified set of image property maps corresponding to the occlusion viewing position by shifting at least the first image property map and the second image property map to the occlusion viewing position; and
determining (407) the occlusion image property map by selecting image properties for pixels of the occlusion image property map from corresponding pixels of the modified set of image property maps.

3. The method of claim 2 wherein the selection between corresponding pixels of the modified set of image property maps is in response to depth values for the corresponding pixels.

4. The method of claim 2 wherein the selection between corresponding pixels comprises selecting an image property for a first pixel of the occlusion image property map as an image property for a corresponding pixel not having a depth value corresponding to a most forward depth for the corresponding pixels for the first pixel.

5. The method of claim 2 wherein the selection between corresponding pixels comprises selecting an image property for a first pixel of the occlusion image property map as an image property for a corresponding pixel having a depth value corresponding to a second most forward depth for the corresponding pixels for the first pixel.

6. The method of claim 2 wherein generating (401, 403, 405) at least one of the modified set of image property maps comprises generating a plurality of image property values for pixels corresponding to overlapping image areas following the shifting.

7. The method of claim 1 wherein an image property represented by the occlusion image property map, the first image property map and the second image property map comprises at least one image property selected from the group consisting of:
image luminosity;
image color;
image object identification;
transparency; and
depth.

8. The method of claim 1 further comprising determining a third image property map by performing the algorithm for a third viewing position, the third viewing position having a second offset relative to the first viewing position; and wherein determining the occlusion image property map is further in response to the third image.

9. The method of claim 8 wherein the first offset is substantially opposite the second offset.

10. The method of claim 1 further comprising generating an image signal comprising the occlusion image property map and only including image property maps for the occlusion viewing position.

11. The method of claim 1 wherein the first offset corresponds to a viewing angle offset in the interval from 2° to 10° with respect to an object at a screen depth.

12. The method of claim 1 wherein the occlusion image property map, the first image property map and the second image property map are images.

13. A computer program product for executing the method of claim 1.

14. A software tool for use with a three dimensional modelling computer program to generate an occlusion image property map for an occlusion viewing position for a three dimensional scene, the occlusion image property map comprising at least some image property values occluded from the occlusion viewing position and the three dimensional modelling computer program comprising an algorithm arranged to generate an image property map for an image representing the three dimensional scene as a function of a viewing position; the software tool being arranged to perform the steps of:
generating (701) a first image property map by performing the algorithm for a first viewing position;
determining (703) a second image property map by performing the algorithm for a second viewing position, the second viewing position having a first offset relative to the first viewing position; and
generating (705) the occlusion image property map in response to the first image property map and the second image property map.

15. An apparatus for generating an occlusion image property map for an occlusion viewing position for a three dimensional scene, the occlusion image property map comprising at least some image property values occluded from the occlusion viewing position; the apparatus comprising:
means (101) for providing an algorithm arranged to generate an image property map for an image representing the three dimensional scene as a function of a viewing position;
means (103) for generating a first image property map by performing the algorithm for a first viewing position;
means (105) for determining a second image property map by performing the algorithm for a second viewing position, the second viewing position having a first offset relative to the first viewing position; and
means (109) for generating the occlusion image property map in response to the first image property map and the second image property map.
